(19) United States
(12) Patent Application Publication
(10) Pub. No.: US 2018/0096426 A1
(43) Pub. Date: Apr. 5, 2018

(54) SYSTEM AND METHOD FOR PROVIDING AND ADMINISTERING LOANS

(71) Applicant: Bridgecare Finance, Inc., Seattle, WA (US)

(72) Inventors: RICHARD MICHAEL CHILES, Bois d'Arc, MO (US); AUDRA MICHELE JUNG, Seattle, WA (US); JAMISON NICOLE HERBERT, San Jose, CA (US)

(21) Appl. No.: 15/722,965

(22) Filed: Oct. 2, 2017

Related U.S. Application Data
(60) Provisional application No. 62/496,003, filed on Oct. 3, 2016.

(51) Int. Cl. G06Q 40/02

(52) U.S. Cl. CPC G06Q 40/025

(57) ABSTRACT

A method and system for financing childcare or another service under more financially and socially favorable terms than conventional financing offers, combined with a system for incentivizing repayment of principal and interest for said loans, and encouraging college saving.

### CROSS REFERENCE TO RELATED APPLICATION

This application claims the benefit of U.S. Provisional Application No. 62/496,003, entitled “Method and System for Securing Socially Beneficial Loans,” filed Oct. 3, 2016, which is incorporated by reference herein in its entirety for all purposes.

### BACKGROUND

The present invention relates generally to methods and systems of securing loans for socially desirable causes, such as childcare, and more specifically, to a loan generation and servicing method that reduces credit risk, increases availability of affordable loans and lowers interest rates for young and/or disadvantaged families in need of funds for childcare, while enabling them to advance their professional careers.

Loans are used for many purposes; to enable purchase of a home or car, provide funds for an event, provide funds to start a business, or to provide funds to take advantage of a service, such as obtaining an education. Typically, a loan is for a set amount (termed the principal) and the loaned funds are repaid by making a series of installment payments of an agreed upon amount, and at an agreed upon frequency for the term of the loan. The total amount repaid is based on the principal, the life of the loan, and the interest rate charged for the loan.

However, in some situations funds may be needed for childcare or another family support service; unfortunately, the cost of such services may be prohibitive and cause a parent or family member to forego a family or career opportunity beneficial to them and their family. For example, a couple who are beginning or early in their career path may desire to start a family, but may be deterred by the cost of childcare. This may cause them to delay starting a family or forego a promising career opportunity, which can have an impact on their future. However, it may not be in society's best interests to deter a couple from starting a family or from taking advantage of a career development opportunity that provides long term benefits to them and to society.

Although a conventional loan of the type described might be able to assist a young parent to pay for childcare, such a loan is often very difficult or impossible for a young parent to obtain. This is primarily because a childcare loan to young parents might be for several tens of thousands dollars (or even close to one hundred thousand dollars), and with a limited credit history and little collateral, young parents may not qualify for a loan, or may only qualify for a loan at an interest rate that makes the loan unrealistic or undesirable.

Embodiments of the inventive system, apparatus, and methods are intended to address and solve these and other problems or disadvantages of conventional loan arrangements, both individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Historically, many loans have been secured by various forms of collateral; such as homes, cars, personal guarantees, and co-signers. If a loan is not paid according to terms, the borrower may lose the collateral, see their credit rating damaged, or have co-signers suffer financial harm. For many, including young families with limited credit history and little collateral, it may be very difficult or impossible to borrow funds to finance quality childcare.

In contrast, embodiments of the inventive system and methods introduce a new and innovative form of collateral; one based on familial and/or social ties to a third party. In one embodiment, as a condition of the loan contract, the borrower is required to make ongoing payments, which are conditionally credited, with imputed interest, to a fund or account for the benefit of a third party, known as the Beneficiary. In some cases, the Beneficiary is an infant or young child for whom a service is being provided. In such cases, the Beneficiary is not a signatory, or a guarantor to the loan agreement. The Beneficiary gains a significant benefit, typically funds for a higher education, if the loan is repaid; but suffers the loss of the fund or account if the loan is not repaid. This innovative form of collateral draws upon social and familial bonds to incentivize borrowers to repay the loan, as the Beneficiary is subject to a loss should the loan not be paid according to terms of the loan.

As mentioned, embodiments of the invention are directed to methods and systems of providing and administering loans for socially desirable causes, such as childcare, and more specifically, to an innovative loan generation and servicing method that reduces credit risk and results in lower interest rates for young and/or disadvantaged families in need of funds for childcare. One benefit of the inventive loan arrangements is to enable parents to make long-term investment and career decisions. In some embodiments, the invention is directed to a method of providing a loan wherein no principal payments to service the loan are made during a specified timeframe, such as when a child is in childcare. Interest payments may or may not be paid during this specified timeframe. Embodiments of the invention; however, require the loan requester to make regular payments in the form of a special “service fee”. This payment is directed to a contingent alternative account, where reference to the “contingent” nature of the account is in recognition of the possible but not certain transfer of funds in the alternative account to a designated beneficiary of the loan contract.

However, only upon satisfaction of the terms of a loan agreement does this transfer take place. In some respects, the alternative account is a unique form of a savings account in which imputed compounded interest is calculated upon the value of the contingent principal during the lifetime of the account. The contingent alternative account, with any imputed interest, is managed by the lender (or the lender's assigned or contractually obligated manager or administrator) and does not become the property of the borrower(s) until an agreed upon event occurs, such as partial or full repayment of the loan. Upon the repayment of the loan (principal and interest, and full or partial repayment, as agreed upon), the funds in the alternative account may be transferred to the contractually defined account beneficiary. Should the borrower not adhere to the terms of the loan, the entire amount of the contingent alternative account, and any imputed interest may default to the lender.

In some embodiments, the borrowing entity may be a loan syndicate or group that includes a family member, an employer, social network or an organization, and that operates as a guarantor for a loan. The syndicate is comprised of people who wish to assist a parent by enabling the parent to receive an acceptable form of loan to pay for childcare without foregoing another opportunity. Each member of the syndicate may commit to repaying a portion (such as a percentage) of the loaned amount, plus the associated interest. This may permit an employer to provide childcare services as a form of employee benefit, subject to certain employment related obligations or conditions.

In some embodiments, an employer or family member may be able to make a contribution to the contingent alternative account as an incentive for the borrower to make full repayment of the loan principal and interest. As before, upon repayment of the loan and compliance with any relevant contractual terms, the funds in the alternative account are transferred to the designated beneficiary.

In one embodiment, a “dashboard” or other form of user interface display is provided and made accessible to the participants in the loan (i.e., the lenders and the borrowers, and possibly to any loan guarantors or administrators). The dashboard displays the current status of the loan payments and may also display the value of the contingent alternative account with any imputed interest, and its projected value at the time the loan is scheduled to be paid. If a member of the loan syndicate fails to make their payment on a timely basis, the dashboard alerts the other members of the syndicate, who may be given a grace period to make up the loan payment deficiency. The members of the syndicate may be notified that if the deficiency is not made up, then the assets of the contingent alternative account will be at risk and may be lost to the alternative account beneficiary.

Note that in some embodiments, an employer, friend or relative of the borrower may provide an incentive to the borrower to become an employee, remain an employee, and/or maintain timely repayment of the loan amount by making a contribution to the alternative account or by providing sufficient funds to the alternative account in order to reduce the interest rate applied to the loan principal for a period of time.

Note that among other benefits, embodiments of the inventive system and methods may be used by employers as part of an effort to recruit and retain employees with family childcare needs (or other family service related needs, such as elder care, after school care, etc.). Embodiments may be especially attractive to employers who do not have employer subsidized childcare facilities on site, but who wish to use similar incentives to recruit and retain employees. In another use case or scenario, embodiments provide a method by which two or more estranged parents or family members may pay for childcare without having to interact with each other. Note that in such a case, the dashboard may be a source of unbiased, factual information for a court authority or other party.

In one embodiment, the “funds” in the alternative account may be replaced, in whole or in part, by the use of “points” which may be converted to a monetary value at a later time. In this embodiment, instead of depositing or crediting “dollars” into the alternative account or phantom account and paying or crediting interest in dollars, “points” are used to represent a certain amount of value.

In one embodiment, the invention is directed to a method of financing a service. The method includes receiving a request for funds for the service from a loan requestor, evaluating the risk of the loan requestor not being able to repay the funds, determining if the risk of the loan requestor not being able to repay the funds is acceptable, and if the risk is acceptable, then making a loan offer to the loan requestor. The loan offer includes creating a contingent alternative account, the contingent alternative account associated with a beneficiary and bound by the terms of the loan offer to a specific loan requestor or loan, and further, wherein the loan requestor specifies the beneficiary of the contingent alternative account. The method further includes providing the requested funds as either a loan or a credit line, providing a set of payments for the service to a provider of the service, receiving a set of service fee payments from the loan requestor while the service is being provided, crediting each received service fee payment to the contingent alternative account, wherein the credited service fees and any imputed interest are not accessible to the beneficiary until the requested funds and any accrued interest due are repaid. After completion of the service being provided, the method includes receiving a payment or payments from the loan requester that represent a portion of the repayment of the requested funds and accrued interest due, and transferring the credited service fees and any imputed interest in the contingent alternative account to the beneficiary of the account after the requested funds and accrued interest due have been repaid.

In another embodiment, the invention is directed to an apparatus for implementing the inventive method, where the apparatus includes a non-transitory data storage element in which is stored a set of instructions and an electronic processor programmed with the set of instructions. When the instructions are executed by the processor, the instructions cause the apparatus to implement an embodiment of the inventive method.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a flowchart or flow diagram illustrating a process, method or operation for enabling a loan to be generated and repaid by use of an alternative account, in accordance with an embodiment of the inventive system and methods; and

FIG. 2 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element (such as a non-transitory computer readable medium). In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or any other suitable form. The following detailed description is, therefore, not to be taken in a limiting sense.

Where possible, terms phrased in the singular or plural are meant to be interchangeable, unless stated otherwise. In accordance with embodiments of the invention, a “loan” may refer to any type of loan, credit, or other transaction in which a source of funds (i.e., the Lender) is subject to the risk of loss. In general, the invention provides a mechanism for financing childcare, and personal and/or family services, under more financially favorable terms than conventional financing methods. Note that the invention may also be used in the financing of products (such as medical supplies, etc.). The inventive financing system lowers a Lender's risk of default by using financial and strong social incentives to encourage responsible financial planning, and rewards responsible repayment of principal and interest by a Borrower, while encouraging college savings and/or another socially beneficial practice.

Although the following description of an implementation of an embodiment of the inventive system and methods may focus on the provision, administration and repayment of a loan for purposes of paying for childcare services, it is noted that the methods and system described herein may be used to provide funding for other purposes. Note that embodiments of the invention may be used for other loan purposes that draw upon social and emotional bonds of parenthood, friendship or other family ties that will help induce timely repayment of loans.

Such purposes may include, but are not limited to one or more of the following use cases or scenarios:
Private school education services
Child/Maternity Focus
Summer/Day Camp
Funding Maternity Care
Funding extraordinary expenses associated with a birth
After school programs
Special needs programs
Specialized job training, e.g., coding boot camp
Eldercare

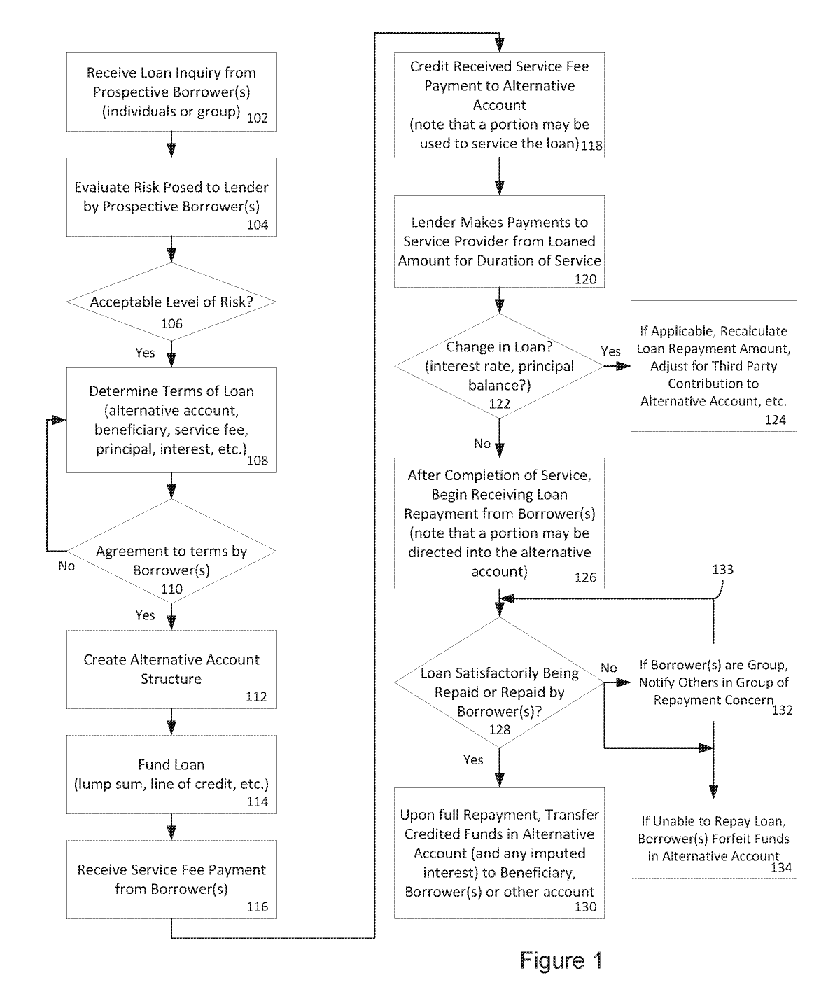

Further, although certain of the steps or stages involved in implementing one or more of the inventive methods may involve the execution of a set of instructions (such as those illustrated in FIG. 1) by a properly programmed electronic processor, one or more of the steps or stages used to implement an embodiment of the inventive loan process may also or instead be implemented by the execution of a separate set of instructions (such as a risk assessment module) and/or by an automated decision process (such as a funding decision based on comparing the risk profile of the prospective borrower(s) to an overall loan portfolio or risk threshold).

### Implementation of an Example Embodiment of the Inventive System and Methods

With regards to providing funding for childcare expenses, it is noted that young people establishing their careers and financial history may want to start a family, but can be deterred by the rising costs of childcare, which may exceed $1500 to $2000 a month. In this regard, embodiments of the invention are especially advantageous to mothers, who often drop out of the labor market for three to five years while their child is young. Leaving the job market to parent for this extended period typically reduces lifetime earning opportunities by as much as 25 to 30%. Further, conventional loans may not be available to them or may be associated with a high interest rate, thereby making the loan undesirable.

In contrast, by using an embodiment of the inventive loan structure and associated methods, a loan source or administrator may advance funds for all or for a portion of childcare expenses on a month-to-month basis. In some embodiments, the advanced funds (the loaned amount) may be combined with partial day care or school payments provided by the parents or guardians, with the consolidated funds paid directly to a child's childcare provider.

However, embodiments of the inventive system and methods also require that a Borrower or Borrowers pay the loan source or loan administrator (typically the Lender) an additional monthly “service fee”, while a child is in childcare (or is otherwise using the services for which the loan is obtained). This monthly service fee is typically retained by the loan source or loan administrator until the loan principal and interest are repaid in full. The service fees are placed into a contingent alternative account, sometimes referred to as a “phantom third-party beneficiary fund”, or Beneficiary Fund. Managers of these funds calculate the value of the sum total of these service fees, and add to each fund the imputed value of a contractually specified interest rate. Ownership and control of all funds in the alternative account are retained by the loan source or loan administrator until the loan has been repaid fully (both principal and interest), or depending on the loan agreement, has been partially repaid in accordance with terms of the loan.

Upon full loan repayment (or partial, if the loan terms so provide), the “phantom” fund plus any previously imputed compound interest may be paid out to the Beneficiary, frequently, but not exclusively for the presumptive benefit of the child receiving the childcare. Note that the inventive system and methods of financing childcare or another service permits the parents maximum flexibility to continue graduate and professional degrees, and/or to maintain a continuous career path. Further, the creation of a contingent (and not guaranteed) college savings plan incentives young parents to emphasize financial planning and to prioritize timely repayment of their loan.

In some embodiments, the inventive system and methods offer multiple personal and social benefits, while providing incentives to reduce potential risk to the Lender. These benefits include, but are not limited to:
Parents are able to maintain educational or career trajectories;
Children receive the benefit of quality day care, and care that their parents might not otherwise be able to afford;
Children and parents are able to develop a significant college savings account while the child is young;
Parents are incentivized to prioritize timely loan repayments;
The Lender may be able to offer lower interest rates to a larger group of parents because of repayment incentives, and has the financial “cushion” of the retained service fees if loans are not repaid;
The Lender receives the benefit of the use of the service fees, while imputing a commercial loan market rate of interest to the funds in the contingent account;
A group of loan guarantors or borrowers may form a loan syndicate to provide the parents with child care services, while encouraging savings for education in the contingent alternative account;
The Borrowers have the incentive of seeing their alternative account funds grow in value and are incentivized to make timely loan payments, rather than risk losing all or a portion of the alternative account funds; and
While in some cases the Borrower may be less sensitive to the loss of their own investment, they are likely to be more sensitive to the loss of the funds in their child's account, and thus more willing to make sacrifices to ensure prompt and timely loan repayments.

FIG. 1 is a flowchart or flow diagram illustrating a process, method or operation for enabling a loan to be generated and repaid by use of an alternative account, in accordance with an embodiment of the inventive system and methods. As shown in the figure, a Lender or other source of funds or loan administration may receive a request for funds from a prospective Borrower (as suggested by step or stage 102). In deciding whether to provide a source of funds to the prospective Borrower(s), the Lender will typically evaluate the risk posed by the Borrower(s), taking into account their job, career trajectory, expected income, stability, and other factors (as suggested by step or stage 104). If the Borrower(s) are a group (such as the referred to “loan syndicate”), then a blended risk evaluation that takes into account the risk presented by each member of the group is typically considered by the Lender. Note that this may allow the Lender to present more favorable terms to the Borrower group than could be obtained by the parents of the child for whom the childcare will be provided.

If the Lender is satisfied that the prospective Borrower(s) are an acceptable risk (as suggested by the “Yes” branch of step or stage 106), then the Lender determines the terms of the loan agreement; these terms may include the creation of an alternative account, the determination of the applicable service fee, the amount of the loan, the applicable interest rate (which may vary during the course of the loan), and the term of the loan (as suggested by step or stage 108).

After determining the relevant terms, the Lender obtains the Borrower's approval of the terms and agreement to abide by the terms proposed by the Lender. If the Borrower approves and agrees to the terms (as suggested by the “Yes” branch of step or stage 110), then the Lender creates the alternative account (sometimes referred to as a “phantom third party beneficiary fund”, as suggested by step or stage 112) and funds the loan, either as a lump sum or credit line accessible by the Borrower (as suggested by step or stage 114). If the Borrower(s) do not accept the proposed terms, then the Lender may revise them (step or stage 108) and present them again for consideration and approval by the Borrower(s) (as suggested by the “No” branch of step or stage 110 and the (re)execution of step or stage 108).

During the term of the loan, the Lender receives payments from the Borrower as follows: (1) a monthly service fee which is typically paid from the starting date of the loan agreement until either (a) the Borrower begins to repay the loan principal and interest, (b) the Borrower has fully repaid the principal and interest, or (c) another specified condition is satisfied (as suggested by step or stage 116), (2) payments of interest, and (3) payments of principal beginning at a defined time or after a defined event, such as graduation from childcare. In some embodiments, interest payments may be made on the current outstanding balance throughout the life of the loan, or alternatively, interest payments may begin after the child care or other service for which the loan principal was advanced is no longer needed (as suggested by step or stage 126).

The service fee received by the Lender is credited to the contingent alternative account, as suggested by step or stage 118. During the period in which the childcare or other service is provided, the Lender makes payments to the service provider from the funded loan, as suggested by step or stage 120. In one embodiment, the Borrower(s) may make a partial payment to the service provider, thereby reducing the amount required for the loan.

During the term of the loan, the interest rate or principal balance may change; this may be the result of a party such as an employer or member of a loan syndicate making a contribution to pay down the balance of the loan and/or making a contribution to the alternative account (as suggested by step or stage 122). In such a situation, the loan repayment amount (i.e., the amount the parents are expected to pay to repay the loan and any accrued interest) may be reduced as a result of the contribution. In other cases, the contribution may increase the amount available to the beneficiary once the funds in the alternative account are transferred from the Lender to the beneficiary (as suggested by step or stage 124).

After completion of the childcare services (e.g., when the child enters formal school or after a certain period in which the services are provided), the Borrower(s) begin repaying the loan and any accrued interest (as suggested by step or stage 126).

If during the repayment process, a loan payment becomes overdue (indicating a problem with repayment, as suggested by the “No” branch of step or stage 128), then the Borrower(s) may receive notification of a concern regarding repayment. For example, if a loan syndicate is responsible for repayment, then the members of the syndicate may receive a message or other form of notification (such as from the previously referenced dashboard or messaging interface) that the Borrower(s) or Borrowing entity is in danger of defaulting on the loan obligation (as suggested by step or stage 132). In response, a member of the syndicate may choose to make a payment in order to preserve the beneficiary's ability to eventually receive the funds in the contingent alternative account (as suggested by the process of path 133 in the figure). As mentioned, in some cases a dashboard or other form of user interface my provide a Borrower or Borrowing entity with information regarding received service fee payments, loan payments, the value of the funds accumulating in the alternative account, the remaining principal on the loan, adjustments to the interest rate, etc.

Once the loan is satisfactorily repaid (as suggested by the “Yes” branch of step or stage 128), the accumulated funds in the alternative account (including any imputed interest) are vested and the Lender will make a payment to the Beneficiary of the alternative account, or to a designated account (such as a college savings account for the benefit of the beneficiary), as suggested by step or stage 130. Note that if the loan obligation is not fulfilled, then the Borrower(s) and beneficiaries forfeit the funds accumulated in the contingent alternative account, as suggested by the “No” branch of step or stage 128, and step or stage 134. Note that in this case, the accumulated funds act as partial offset to any costs or losses incurred by the Lender.

As noted, the contingent alternative account balance or “phantom fund” (which is typically, but not exclusively, funded by the monthly or other timed service fee) is the property of the Lender until the loan is repaid in full or another specified condition is satisfied. The funds in the alternative account may accrue imputed compound interest under the terms of the loan agreement. When the loan has been repaid in full (or another applicable condition is satisfied), the funds in the alternative account (which include the monthly service fee, additional contributions by interested parties, and accrued interest) may be transferred to the beneficiary of the alternative account (which may be the child) or to another account (such as a college savings plan) intended to benefit the beneficiary (who as noted, is not a party to the loan).

The beneficiary, phantom, or alternative account may be used to accumulate funds for a variety of purposes; these may include, but are not limited to:
Higher education for a child;
Down payment on a home; or
Retirement savings.

As mentioned, the accumulated funds in the alternative account may be provided by one or more sources, including but not limited to:
Service fees paid by Borrower(s) or in the case of a syndicate of guarantors, the persons accepting the benefits of the loan;
A portion or percentage of the interest paid by the Borrower(s)—e.g., a borrower might be paying 12% interest on the loan principal, but funds corresponding to 2% of the interest might be deposited into or credited to the alternative account balance;
The Borrower pays the agreed upon interest, but as satisfactory repayment of the principal and interest is demonstrated or completed, a percentage of the loan value is credited to, and credited to the alternative account for the benefit of the beneficiary; or
A percentage of the principal borrowed (or a fixed amount) is credited to the alternative account and made available to the beneficiary upon satisfactory payment of the loan.

The inventive loan mechanism may provide advantages over conventional loans. For example, the Borrower may be offered more favorable loan terms than a conventional loan would permit, where these terms include provisions for the creation and funding of the alternative account. In some embodiments, the Lender may agree to participate in the loan process under the terms of the loan and to credit “phantom” interest payments on the funds in the alternative account as an additional incentive to the Borrower to maintain timely service fee and loan payments. Note that the Lender's elective provision to credit “interest” payments is contingent on the Borrower staying current on the terms of the loan. In this way, both the Lender and the Borrower have additional shared and common interests in participating in the loan agreement.

As funds in the alternative account accumulate, the Lender retains custody, control, and ownership of the funds. A compounded rate of interest on the accumulated service fees may be calculated and imputed to the value of the beneficiary's alternative account or “phantom” fund. During the life of the loan, the Borrower(s) may receive regular statements or be able to access a user interface to determine the “value” of the beneficiary's phantom fund, plus any imputed accrued “interest”.

In one embodiment, the Borrower may not be obligated to make any repayment of the loan principal or interest until the service for which the loan was made is no longer needed (such as when the child enters school or is otherwise no longer in need of childcare services). In one embodiment, the Borrower may not be obligated to make any repayment of the loan principal, while still paying interest, until the service for which the loan was made is no longer needed (such as when the child enters school or is otherwise no longer in need of childcare services). In one embodiment, as the Borrower makes loan repayments, a portion of each payment is used to service the loan, and a portion is used to make payments/contributions to the alternative account (as suggested by step or stage 126 of FIG. 1). Note that the service fee or other contribution to the alternative account may be designated as a loan loss reserve, service fee, or another form that does not trigger applicable usury laws and/or minimizes or defers any unfavorable tax consequences.

As noted, after the loan is repaid in full (or another agreed upon condition is satisfied), the funds in the alternative account may be disbursed (according to the contractual terms) to the Beneficiary. This disbursement may take the form of a contribution to a 529 or equivalent tax advantaged college savings fund, a trust fund, or other beneficial purpose as designated in the loan documents. In some cases the ultimate beneficiary of the fund may be the child whose childcare was financed by the original loan. In other cases the beneficiary may be a charitable cause, or another third party.

As mentioned in the description of the invention, while parents are typically expected to be the Borrowers, embodiments of the inventive loan system and methods are not restricted to participation by parents. Other parties may participate in the loan agreement (e.g., by forming a loan syndicate), such as friends, aunts, uncles, siblings, grandparents, step parents, god-parents, employers or other interested parties. Further, while an intended purpose of the alternative account funds is to help create incentives for effective savings for higher education, the accumulated funds may be paid out for other purposes as may be contractually described in the Lender's loan documents.

As described herein, in some embodiments, a Lender or Borrower may provide for one or more of the following variations or adjustments to the manner in which the loan is serviced, repaid, or the alternative account is funded:
a portion of the Borrower's loan repayment may be allocated or contributed to the alternative account, with the remainder used for payment of interest and/or principal (as suggested by step or stage 126 of FIG. 1);
a third party (employer, grandparent, etc.) may make a contribution to the alternative account (e.g., a form of employee benefit) for the eventual benefit of the account's beneficiary (who may be one of the Borrowers, the child receiving the childcare services, a charitable institution, or another party);
a third party may make a payment to the Lender which operates to adjust the amount of interest charged on the loan and/or reduce the amount of principal required to be repaid (as suggested by step or stage 124 of FIG. 1);
the Lender may agree to impute fixed, enhanced or variable “phantom” interest payments to the funds in the contingent alternative account as an additional incentive to the Borrower; this is typically contingent on the Borrower staying current on the terms of the loan. In this way, both the Lender and Borrower have an additional shared and common interest in fulfilling the terms of the loan agreement; and
a user interface and notification system (such as email, text, dashboard or other method) may be used to inform one or more of those in a group of Borrowers (such as a loan syndicate) that loan repayment is in jeopardy, and to permit a member of the group to make a loan payment or take other action to preserve the parent's right to the funds in the alternative account (as suggested by step or stage 132 and process flow 133 of FIG. 1), but only as a secondary or contingent Beneficiary.

In one embodiment, the “funds” in the alternative account may be replaced, in whole or in part, by the use of “points” which may be converted to a monetary value at a later time. In this embodiment, instead of depositing or crediting “dollars” into the alternative account or phantom account and paying or crediting interest in dollars, “points” are used to represent a certain amount of value. For example, points could be provided according to an exchange rate of one point for one dollar, (or in another reasonable conversion ratio, where the exchange rate may possibly vary if specified conditions are met or not met, such as if repayment is on schedule or not, or if a certain balance is met for the alternative account). For instance, for every $1,000 borrowed, 20 points may be credited to the alternative account. For interest paid, a formula may be used to convert the value of the imputed interest to a point value, with the equivalent amount of points credited to the alternative account.

Note that an advantage of using such a point based system is that it avoids simplify or minimize certain fiduciary and tax issues associated with maintaining each Benefit Fund. Points can be debited according to various formulas, such as for a late payment, and failure to repay the loan may result in the complete loss of points credited to the account. Under one option, the Lender may deposit funds in an escrow account, thereby guaranteeing the value of the points at a future date; under another option the Lender may pay an insurance company a premium to guarantee payment or conversion of the points at a later date.

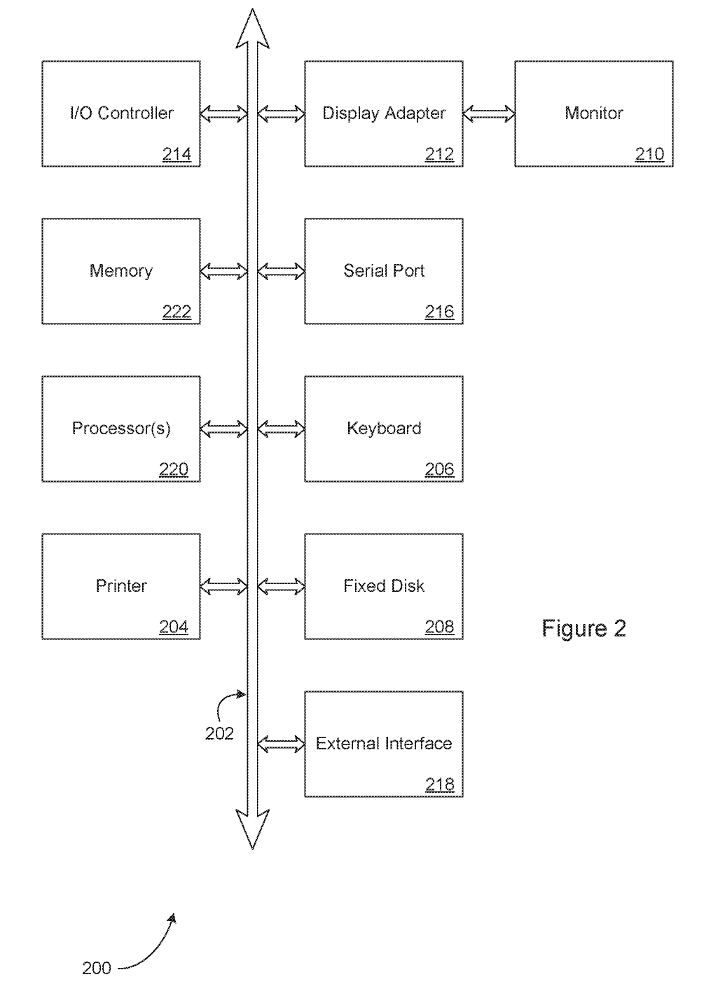

FIG. 2 is a diagram illustrating elements or components that may be present in a computer device or system configured to implement a method, process, function, or operation in accordance with an embodiment of the invention. As noted, in some embodiments, the inventive system and methods may be implemented in the form of an apparatus that includes a processing element and set of executable instructions. The executable instructions may be part of a software application and arranged into a software architecture. In general, an embodiment of the invention may be implemented using a set of software instructions that are designed to be executed by a suitably programmed processing element (such as a CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement or represent one or more aspects of the inventive system and methods, such as for:
receiving an inquiry from a prospective borrower regarding a possible loan;
evaluating the risk presented by the prospective borrower or borrowers regarding repayment of the proposed loan;
determining the loan terms (e.g., the type and structure of the alternative account, the beneficiary of the alternative account, service fee payment, loan repayment schedule, principal amount, interest applied);
presenting the proposed loan terms to the borrower or borrowers and receiving their approval;
funding the loan or credit line and establishing the alternative account;
receiving regular service fee payments from the borrower or borrowers;
depositing or transferring the received service fee payments to the alternative account;
drawing from the funded loan or credit line to make payments to the service provider;
after completion of the service (or at another contractually agreed upon time or event), receiving payments from the Borrower(s) to be applied to payment of the accrued interest on the loan and/or the principal of the loan;
if there is an interruption in one or more of the Borrowers' repayments, notifying or alerting one or more of the remaining Borrowers of a potential default on the loan and risk of the loss of the accumulated funds in the alternative account;
receiving a payment from one or more of the remaining Borrowers and applying it to the loan to make the loan repayments up to date; and
after full repayment of the loan, including interest and principal, transferring or otherwise providing ownership and control of the accumulated funds in the alternative account to the Beneficiary of the alternative account.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As described, the system, apparatus, methods, processes, functions, and/or operations for implementing an embodiment of the invention may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 2 is a diagram illustrating elements or components that may be present in a computer device or system 200 configured to implement a method, process, function, or operation in accordance with an embodiment of the invention. The subsystems shown in FIG. 2 are interconnected via a system bus 202. Additional subsystems include a printer 204, a keyboard 206, a fixed disk 208, and a monitor 210, which is coupled to a display adapter 212. Peripherals and input/output (I/O) devices, which couple to an I/O controller 214, can be connected to the computer system by any number of means known in the art, such as a serial port 216. For example, the serial port 216 or an external interface 218 can be utilized to connect the computer device 200 to further devices and/or systems not shown in FIG. 2 including a wide area network such as the Internet, a mouse input device, and/or a document scanner. The interconnection via the system bus 202 allows one or more processors 220 to communicate with each subsystem and to control the execution of instructions that may be stored in a system memory 222 and/or the fixed disk 208, as well as the exchange of information between subsystems. The system memory 222 and/or the fixed disk 208 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method of financing a service, comprising:
receiving a request for funds for the service from a loan requestor;
evaluating the risk of the loan requestor not being able to repay the funds;
determining if the risk of the loan requestor not being able to repay the funds is acceptable;
if the risk is acceptable, then making a loan offer to the loan requestor, wherein the loan offer includes creating a contingent alternative account, the contingent alternative account associated with a beneficiary and bound by the terms of the loan offer to a specific loan requestor or loan, and further, wherein the loan requestor specifies the beneficiary of the contingent alternative account;
providing the requested funds as either a loan or a credit line;
providing a set of payments for the service to a provider of the service;
receiving a set of service fee payments from the loan requestor while the service is being provided;
crediting each received service fee payment to the contingent alternative account, wherein the credited service fees and any imputed interest are not accessible to the beneficiary until the requested funds and any accrued interest due are repaid;
after completion of the service being provided; receiving a payment or payments from the loan requestor that represent a portion of the repayment of the requested funds and accrued interest due; and
transferring the credited service fees and any imputed interest in the contingent alternative account to the beneficiary of the account after the requested funds and accrued interest due have been repaid.

2. The method of claim 1, wherein the beneficiary is a child of the loan requestor and the service is a child care service.

3. The method of claim 1, wherein the recipient of the request for funds is a lender, and the lender determines an imputed interest rate to be applied to the credited service fee payments in the contingent alternative account.

4. The method of claim 1, wherein the service is one of education services, Summer or Day Camp, Maternity Care, expenses associated with a birth, an after school program, a special needs program, job training, or a form of eldercare.

5. The method of claim 1, wherein the loan requestor is a loan syndicate.

6. The method of claim 1, further comprising crediting a portion of the credited service fee payments in the contingent alternative account to repayment of the requested funds or accrued interest.

7. The method of claim 1, further comprising crediting a portion or percentage of the received payment or payments from the loan requestor to the contingent alternative account.

8. The method of claim 1, further comprising receiving a payment that is not a service fee payment or a portion of the repayment of the requested funds and accrued interest, and in response crediting the received payment to the contingent alternative account.

9. The method of claim 3, further comprising the lender retaining the credited service fees and any imputed interest in the contingent alternative account if the loan requestor does not comply with a term or terms of the loan.

10. The method of claim 1, wherein the imputed interest may be varied depending on the loan requester's performance in satisfactorily conforming to the terms of the loan agreement.

11. An apparatus for financing a service, comprising:
a non-transitory data storage element in which is stored a set of instructions; and
an electronic processor programmed with the set of instructions, wherein when executed by the processor the instructions cause the apparatus to
receive a request for funds for the service from a loan requestor;
evaluate the risk of the loan requestor not being able to repay the funds;
determine if the risk of the loan requestor not being able to repay the funds is acceptable;
if the risk is acceptable, then make a loan offer to the loan requestor, wherein the loan offer includes creating a contingent alternative account, the contingent alternative account associated with a beneficiary and bound by the terms of the loan offer to a specific loan requestor or loan, and further, wherein the loan requestor specifies the beneficiary of the contingent alternative account;
provide the requested funds as either a loan or a credit line;
provide a set of payments for the service to a provider of the service;
receive a set of service fee payments from the loan requestor while the service is being provided;
credit each received service fee payment to the contingent alternative account, wherein the credited service fees and any imputed interest are not accessible to the beneficiary until the requested funds and any accrued interest due are repaid;
after completion of the service being provided, receive a payment or payments from the loan requestor that represent a portion of the repayment of the requested funds and accrued interest due; and
transfer the credited service fees and any imputed interest in the contingent alternative account to the beneficiary of the account after the requested funds and accrued interest due have been repaid.

12. The apparatus of claim 11, wherein the beneficiary is a child of the loan requestor and the service is a child care service.

13. The apparatus of claim 11, wherein the recipient of the request for funds is a lender, and the lender determines an imputed interest rate to be applied to the credited service fee payments in the contingent alternative account.

14. The apparatus of claim 11, wherein the service is one of education services, summer or day camp, maternity care, expenses associated with a birth, an after school program, a special needs program, job training, or a form of eldercare.

15. The apparatus of claim 11, wherein the loan requestor is a loan syndicate.

16. The apparatus of claim 11, further comprising instructions that cause the apparatus to credit a portion of the credited service fee payments in the contingent alternative account to repayment of the requested funds or accrued interest.

17. The apparatus of claim 11, further comprising instructions that cause the apparatus to credit a portion or percentage of the received payment or payments from the loan requestor to the contingent alternative account

18. The apparatus of claim 11, further comprising instructions that cause the apparatus to receive a payment that is not a service fee payment or a portion of the repayment of the requested funds and accrued interest, and in response credit the received payment to the contingent alternative account.

19. The apparatus of claim 13, further comprising instructions that cause the apparatus to enable the lender to retain the credited service fees and any imputed interest in the contingent alternative account if the loan requestor does not comply with a term or terms of the loan.

20. The apparatus of claim 10, wherein the imputed interest may be varied depending on the loan requestor's performance in satisfactorily conforming to the terms of the loan agreement.
